(19) United States
(12) Patent Application Publication
(10) Pub. No.: US 2026/0149805 A1
(43) Pub. Date: May 28, 2026

(54) IMAGE QUALITY ASSESSMENT MESSAGE FOR VIDEO CODING FOR MACHINE(VCM)

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: Se Yoon JEONG, Daejeon (KR); Youn Hee KIM, Daejeon (KR); JooYoung LEE, Daejeon (KR); Jung Won KANG, Daejeon (KR); Seongbae Rhee, Yongin-si (KR); Kyu Heon KIM, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/178,648

(22) Filed: Apr. 14, 2025

(30) Foreign Application Priority Data
Apr. 15, 2024 (KR) 10-2024-0050266
Jul. 8, 2024 (KR) 10-2024-0089808
Oct. 28, 2024 (KR) 10-2024-0148878

(51) Int. Cl. H04N 19/117; H04N 19/136; H04N 19/172; H04N 19/46

(52) U.S. Cl. CPC H04N 19/117; H04N 19/136; H04N 19/172; H04N 19/46

(57) ABSTRACT

The encoding/decoding method, device and recording medium of the present disclosure may include receiving an image quality assessment message from a bitstream, determining whether to perform filtering based on image quality assessment information of the image quality assessment message; and selectively performing filtering of a current picture based on whether to perform the filtering.

### CROSS-REFERENCE TO RELATED APPLICATIONS

This application claims the benefit of earlier filing date and right of priority to Korean Application NO. 10-2024-0050266, filed on Apr. 15, 2024, priority to Korean Application NO. 10-2024-0089808, filed on Jul. 8, 2024, priority to Korean Application NO. 10-2024-0148878, filed on Oct. 28, 2024, and priority to Korean Application NO. 10-2025-0048207, filed on Apr. 14, 2025, the contents of which are all hereby incorporated by reference herein in their entirety.

### TECHNICAL FIELD

The present disclosure may correspond to a technical field related to video coding for machines (VCM) standard.

### BACKGROUND ART

In VCM, post-processing work may be performed to improve the performance of human/machine tasks, and in this case, an image quality assessment message and a framework expected to be required for efficient post-processing work may be defined.

### DISCLOSURE

### Technical Problem

Metadata signaling is required to effectively use a video encoding standard for various applications, and for this purpose, a separate VSEI standard has been established starting from a VVC standard. VSEI may be composed of related video usability information (VUI) and supplemental enhancement information (SEI) of metadata nature. For VCM, standardization is being carried out by sending metadata directly to a bitstream.

In the VCM of the present disclosure, a post-processing process may be performed to improve the performance of human/machine tasks. In addition, the present disclosure may be intended to define an image quality assessment message and a framework expected to be required to efficiently perform the process. The framework of the present disclosure may be intended to compare an image quality assessment message/information delivered by measuring image quality for an original image input from an encoding device with an image quality assessment message/information measuring image quality for an image decoded in a decoding device and perform post-processing more efficiently by applying post-processing filtering only when a specific condition is satisfied.

### Technical Solution

The encoding/decoding method, device and recording medium of the present disclosure may include receiving an image quality assessment message from a bitstream, determining whether to perform filtering based on image quality assessment information of the image quality assessment message and selectively performing filtering of a current picture based on whether to perform the filtering.

In the encoding/decoding method, device and recording medium of the present disclosure, the current frame may be a frame interpolated through temporal resampling.

In the encoding/decoding method, device and recording medium of the present disclosure, determining whether to perform the filtering may include determining whether the image quality assessment information is valid, and in response to the image quality assessment information being valid, determining whether to perform the filtering based on the image quality assessment information.

In the encoding/decoding method, device and recording medium of the present disclosure, whether the image quality assessment information is valid may be determined by a flag value included in the image quality assessment message.

In the encoding/decoding method, device and recording medium of the present disclosure, whether to perform the filtering may be determined based on whether an image quality assessment score of the current frame is greater than a threshold value.

In the encoding/decoding method, device and recording medium of the present disclosure, the image quality assessment score of the current frame may be obtained based on the image quality assessment score of frames obtained at a temporal resampling period interval.

In the encoding/decoding method, device and recording medium of the present disclosure, whether to perform the filtering may be determined based on whether the image quality assessment information is valid.

In the encoding/decoding method, device and recording medium of the present disclosure, whether to perform the filtering may be determined by comparing an image quality assessment score obtained on an encoding side with an image quality assessment score obtained on a decoding side.

### Technical Effect

When the present disclosure is applied, the performance of human/machine tasks of VCM may be improved efficiently.

### BRIEF DESCRIPTION OF DRAWINGS

FIG. 1 is a block diagram of an image encoder according to an embodiment of the present disclosure.

FIG. 2 is a block diagram of an image decoder according to an embodiment of the present disclosure.

FIG. 3 is a diagram for describing a consumer of an encoding technology for a machine described in the present disclosure.

FIG. 4 is a diagram for describing a video encoding process for a machine described in the present disclosure.

FIG. 5 is a diagram for describing an image quality difference between video frames mentioned in the present disclosure.

FIG. 6 is a diagram for describing a sequence-level temporal resampling process and a sequence-level temporal resampling reconstruction process mentioned in the present disclosure.

FIG. 7 is a diagram for describing an embodiment of a post-processing filter mentioned in the present disclosure.

FIG. 8 is a diagram for describing a step for generating, transmitting and utilizing an image quality assessment message for video coding for machine (VCM) in the present disclosure.

FIG. 9 shows an embodiment of an image quality assessment message for video coding for machine (VCM) in the present disclosure.

FIG. 10 shows an embodiment of an image quality assessment message for video coding for machine (VCM) in the present disclosure.

FIG. 11 is a diagram for describing a case where a coding technology for machines in the present disclosure is utilized as an element technology in a temporal resampling reconstruction process.

FIG. 12 is a diagram for describing an embodiment of a post-processing filter mentioned in the present disclosure.

FIG. 13 shows a MPEG VCM encoder/decoder structure diagram.

FIG. 14 shows an embodiment in which an image quality assessment message is extracted.

FIG. 15 shows an embodiment of a ROI processing process of VCM.

FIG. 16 shows another embodiment in which an image quality assessment message is extracted.

FIGS. 17 and 18 show another embodiment of a syntax element for conveying image quality assessment information for video coding for machine (VCM) in the present disclosure.

FIG. 19 shows a flowchart for a VCM encoder and a VCM decoder according to an embodiment of the present disclosure.

FIG. 20 shows an example of each sampled pivot frame in temporal resampling.

FIG. 21 shows an embodiment in which an image quality assessment score of intermediate frames interpolated through temporal resampling is obtained.

FIG. 22 shows an embodiment of a condition in which filtering for intermediate frames interpolated through temporal resampling is selectively performed.

FIG. 23 shows a VCM CTC experiment result according to the present disclosure.

### MODE FOR INVENTION

As the present disclosure may make various changes and have multiple embodiments, specific embodiments are illustrated in a drawing and are described in detail in a detailed description.

But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment.

Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

A picture and a frame in the present disclosure may be used interchangeably with the same meaning.

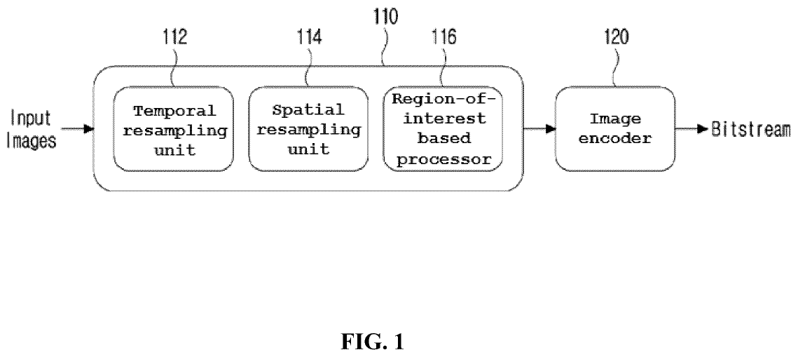

FIG. 1 is a block diagram of an image encoder according to an embodiment of the present disclosure.

Referring to FIG. 1, an image encoder may include a preprocessor 110 and an image encoder 120.

A preprocessor 110 performs a preprocessing process to convert input original images into images suitable for image encoding. In this case, an image input to a preprocessor 110 may be a color or black-and-white image conforming to a YUV or YCbCr format.

A preprocessor 110 may include at least one of a temporal resampling unit 112, a spatial resampling unit 114 or a region-of-interest-based processor 116.

A temporal resampling unit 112 may temporally resample images. Only resampled images may be selected for image encoding. In other words, encoding of some of the images input to a preprocessor 110 may be omitted through temporal resampling. As an example, a 60 fps (frame per second) image may be converted into a 30 fps image by omitting the odd-numbered image of a 60 fps image. Alternatively, an image in a specific output order may be omitted by considering temporal redundancy between images.

A spatial resampling unit 114 may spatially resample an image. The size and/or spatial resolution of an image may be reduced through spatial resampling. As an example, an image with a resolution of 1920×1080 may be converted into an image with a resolution of 960×540 or 480×270, etc.

A region-of-interest-based processor 116 sets a region of interest in an image to ensure that image encoding/decoding is performed focusing on information important for machine inference tasks. A region-of-interest-based processor 116 may remove a background region excluding a set region of interest or adjust the size and/or position of a region of interest in an image to set a region of interest to be encoded/decoded with high quality.

An image encoder 120 encodes an image output from a preprocessor 110. Meanwhile, an image encoder 120 may encode an image by utilizing a conventional codec technology or a codec technology modified for video coding for machine (VCM) based on a conventional codec technology. As an example, an image encoder 120 may encode an image based on HEVC, VVC or AV1. As a result of image encoding, a bitstream is generated and a generated bitstream may be transmitted to an image decoder.

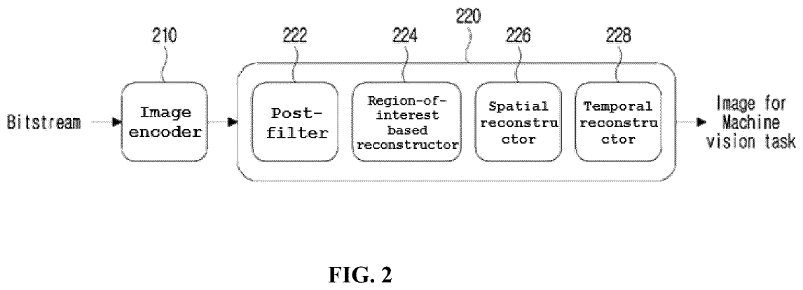

FIG. 2 is a block diagram of an image decoder according to an embodiment of the present disclosure.

Referring to FIG. 2, an image decoder may include an image decoder 210 and a post-processor 220.

An image decoder 210 decodes a bitstream received from an image encoder 110 to generate a decoded or reconstructed image. An image decoder 210 may decode a bitstream based on a codec technology used in an image encoder 120.

A post-processor 220 performs post-processing on a decoded image. Through post-processing, the size and frame rate of an image may be reconstructed according to an original image.

A post-processor 220 may include at least one of a post-filter 222, a region-of-interest-based reconstructor 224, a spatial reconstructor 226 or a temporal reconstructor 218.

A post-filter 222 applies filtering to reduce the reconstruction error of a decoded image. As an example, a post-filter 222 may apply an in-loop filter to a decoded image. An in-loop filter may include at least one of a deblocking filter, a sample adaptive offset filter, a luma mapping chroma scaling (LMCS) filter or an adaptive loop filter.

A region-of-interest-based reconstructor 224 obtains an image of the same size as an original image based on region-of-interest information. As an example, when an image cropped to include a region of interest is encoded, a decoded image has a different size from an original image. Accordingly, a region-of-interest-based reconstructor may adjust a retargeted image to an original size. Here, a retargeted image may represent a decoded image or an image on which upscaling is performed through a spatial reconstructor 226. Alternatively, when the size or position of a region of interest in an encoding target image is adjusted, a region-of-interest-based reconstructor 224 may adjust the position and size of a region of interest in a retargeted image according to an original image.

A spatial reconstructor 226 performs upscaling on a decoded image. A decoded image may be reconstructed to have the same size and/or spatial resolution as an original image through upscaling.

A temporal reconstructor 228 reconstructs an image at a temporal position where encoding/decoding is omitted through temporal resampling. Specifically, a temporal reconstructor 228 may generate an image at a temporal position where encoding/decoding is omitted through interpolation between decoded images.

Meanwhile, in order to perform inverse processing on image processing performed in a preprocessor 110, additional information may be encoded and signaled. A post-processor 220 may perform post-processing on a decoded image based on the additional information to generate an image for performing machine inference in a machine. Meanwhile, additional information may be referred to as ‘metadata’.

Metadata may include at least one of temporal resampling information, spatial resampling information or region-of-interest processing information.

The temporal resampling information may include at least one of a flag representing whether temporal resampling is performed or information representing a temporal resampling rate.

As an example, when the flag is 1, it represents that temporal resampling is performed. In this case, information representing a temporal resampling rate may be additionally encoded/decoded. When temporal resampling is performed, fewer images than the number of original images may be encoded/decoded. An image decoder may reconstruct an image for which encoding/decoding is omitted through temporal reconstruction.

On the other hand, when the flag is 0, it represents that temporal resampling is not performed.

A temporal resampling rate may be expressed as an exponent of 2. As an example, when a temporal resampling rate is 2\hat{ }N, it represents that one of 2\hat{ }N images is selected as an encoding/decoding target image. For example, only images that a picture order count (POC) is a multiple of 2\hat{ }N may be encoded/decoded. Information representing a temporal resampling rate may represent the exponent (i.e., N) of a temporal resampling rate. As an example, the information may represent the exponent value of a temporal resampling rate or a value obtained by subtracting 1 from an exponent value.

The spatial resampling information may include at least one of a flag representing whether spatial resampling is performed or information representing a scaling parameter for spatial resampling.

As an example, when the flag is 1, it represents that spatial resampling is performed. In this case, information representing a scaling parameter may be additionally encoded. Specifically, information representing a horizontal scaling parameter and information representing a vertical scaling parameter may be encoded and signaled, respectively. When spatial resampling is performed, the size and/or spatial resolution of an image may be reduced. An image decoder may reconstruct the size of a decoded image to the size of an original image or a pre-set size through spatial reconstruction. Meanwhile, information for designating a pre-set size may be additionally encoded/decoded.

When the flag is 0, it represents that spatial resampling is not performed.

The region-of-interest processing information may include at least one of image size information or region-of-interest information.

The image size information may include information representing whether retargeting is performed. When a retargeting flag is 1, it represents that a retargeted image is encoded/decoded instead of an original image. On the other hand, when a retargeting flag is 0, it represents that an original image is encoded/decoded as it is.

A retargeted image represents an image generated by performing at least one of resolution adjustment and position adjustment on at least one region of interest in an original image. Accordingly, the resolution or position of a region of interest in a retargeted image may be different from that of an original image. In addition, the size of a retargeted image may be the same as or smaller than that of an original image.

When retargeting is allowed (i.e., when a retargeting flag is 1), the size information of a retargeted image may be encoded/decoded. The size information of a retargeted image may include the width information of an image and the height information of an image.

Meanwhile, information representing a size difference between an original image and a retargeted image may be additionally encoded/decoded. As an example, information representing whether a difference between the size of a retargeted image and the size of an original image is encoded/decoded may be encoded/decoded.

As an example, when information representing whether a size difference is encoded/decoded is 0, it represents that a size difference between a retargeted image and an original image is not encoded/decoded.

On the other hand, when information representing whether a size difference is encoded/decoded is 1, it represents that a size difference between a retargeted image and an original image is encoded/decoded. In this case, information representing a difference between the size of a retargeted image and the size of an original image may be additionally encoded/decoded.

Information representing a size difference represents a size difference between an original image and a retargeted image. Meanwhile, information representing a horizontal size difference and information representing a vertical size difference may be encoded and signaled, respectively.

The region-of-interest information may include at least one of a flag indicating whether a region of interest exists, information on the number of regions of interest, the scaling parameter of a region of interest or position information of a region of interest.

As an example, when the flag is 1, it represents that information on a region of interest is encoded/decoded. In this case, at least one of the number of regions of interest, scaling parameter information of a region of interest, position information of a region of interest or size information of a region of interest may be additionally encoded/decoded.

On the other hand, when the flag is 0, it represents that a region of interest does not exist.

Information on the number of regions of interest represents the number of regions of interest. Meanwhile, the number of regions of interest may be calculated in the unit of an image group including at least one image.

The scaling parameter of a region of interest represents a scaling parameter for a region of interest. According to the scaling parameter of a region of interest, the size of a region of interest may be adjusted.

Scaling parameter information of a region of interest may include information representing whether the scaling parameter of a region of interest is updated. When information representing whether update is performed represents that the scaling parameter of a region of interest is not updated, the scaling parameter of a region of interest may be set as a default value or the same value as in a previous frame. On the other hand, when information representing whether update is performed indicates that the scaling parameter of a region of interest must be updated, information representing the scaling parameter of a region of interest may be additionally encoded/decoded.

Meanwhile, scaling parameter information of a region of interest may be encoded/decoded individually for each region of interest.

Position information of a region of interest represents the position of a region of interest in an original image. In this case, the horizontal position (i.e., x-axis coordinate) information and vertical position (i.e., y-axis coordinate) information of a region of interest may be encoded/decoded, respectively.

Size information of a region of interest represents the size of a region of interest in an original image. In this case, the horizontal size (i.e., width) information and vertical size (i.e., height) information of a region of interest may be encoded/decoded, respectively.

Video Coding for Machine (VCM) is a technology that is being discussed by an international standardization organization, the Moving Picture Expert Group (MPEG), to efficiently compress a video while securing a certain level of machine task performance, and the present disclosure may relate to metadata or a VSEI message that is expected to be required to support efficient use of a post-processing filter for improving the performance of human/machine tasks after reconstructing a bitstream compressed through encoding for machines.

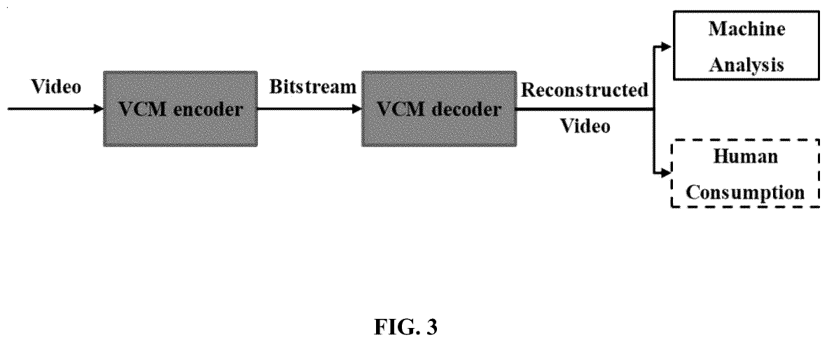

FIG. 3 is a diagram for describing a consumer of an encoding technology for a machine described in the present disclosure.

As shown in FIG. 3, video coding for machine (VCM) includes a pair of a VCM encoder and a VCM decoder, and may be a video encoding technology that supports machine consumption or hybrid consumption of machines and humans. The human consumption mentioned in the present disclosure refers to a typical human video viewing, and the machine consumption may include performing all machine tasks such as object classification, object recognition, object detection, object segmentation, object tracking, super resolution, frame interpolation, etc. through a video.

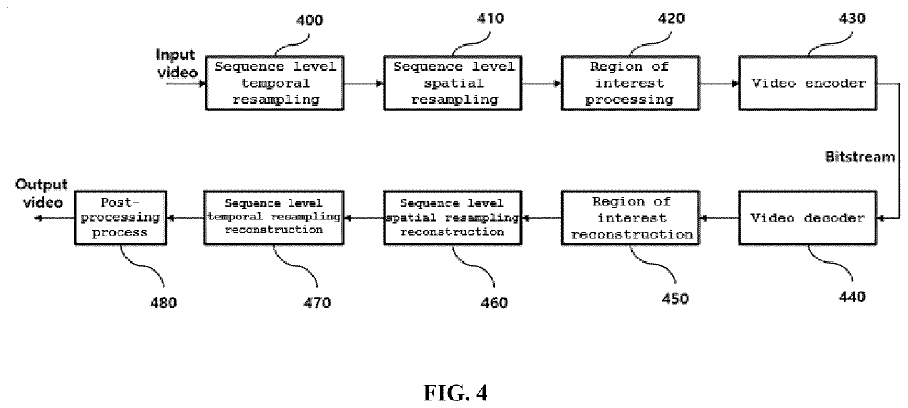

FIG. 4 is a diagram for describing a video encoding process for a machine described in the present disclosure.

As shown in FIG. 4, video coding for machine (VCM) may perform encoding through the process of sequence level temporal resampling 400, sequence level spatial resampling 410, region of interest processing 420 and video encoder 430 to improve the compression efficiency of a video while maintaining machine task performance. A decoding process is composed of a video decoder 440, region of interest reconstruction 450, sequence level spatial resampling reconstruction 460 and sequence level temporal resampling reconstruction 470, and a post-processing process 480 may be performed, if necessary.

A method in FIG. 4 may be used under the name of Temporal/Spatial Resampling Tool.

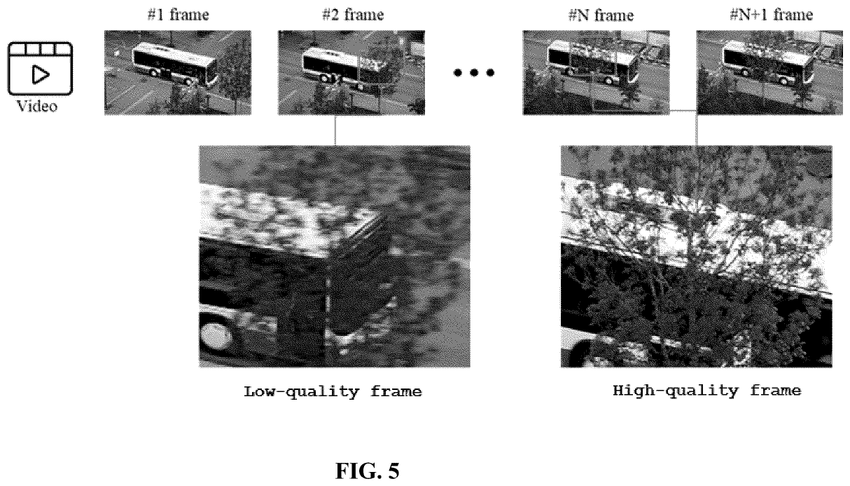

FIG. 5 is a diagram for describing an image quality difference between video frames mentioned in the present disclosure.

As shown in FIG. 5, in a video, an image quality difference may occur between video frames due to a change in illumination, camera focus, objects, camera movements, etc. during shooting. In this case, from the perspective of human consumption, a low-quality frame is less appropriate than a high-quality frame, and from the perspective of machine consumption, a low-quality frame may not be appropriate because it may degrade machine task performance such as object detection, object region partition, etc.

It may be a problem that occurs when a temporal/spatial resampling tool is used.

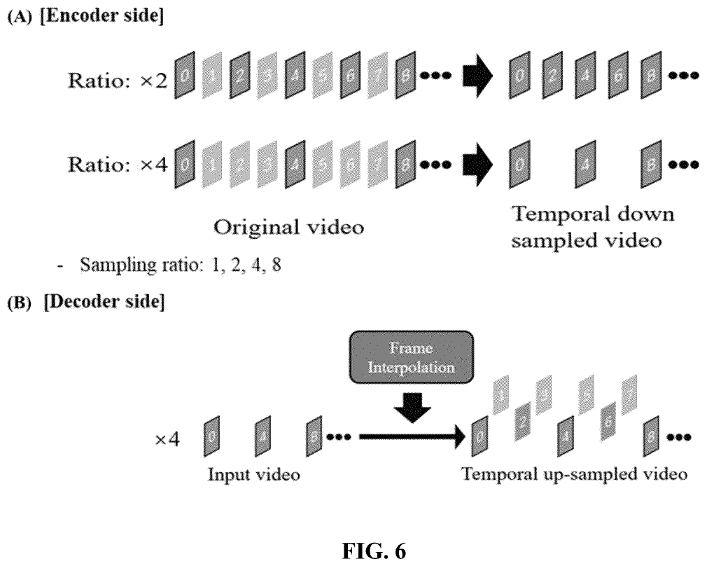

FIG. 6 is a diagram for describing a sequence-level temporal resampling process and a sequence-level temporal resampling reconstruction process mentioned in the present disclosure.

In addition, an image quality difference between video frames may degrade the performance of an encoding technology for machines. As an example, in an encoding process for machines, sequence level temporal resampling 400 may reduce the total amount of data by discarding some frames among the video frames as shown in FIG. 6(A), and in a decoding step, may reconstruct a discarded frame by using a frame interpolation method as shown in FIG. 6(B). A frame interpolation method generates a frame through optical flow estimation based on a correlation between preserved frames, and in this case, when a quality difference occurs between video frames, an inaccurate correlation may be calculated, generating a distorted frame. Finally, this distorted frame may degrade machine task performance. As a method for supplementing this, filtering is additionally used.

In the present disclosure, the content of filtering is described based on deblurring, but it is for the convenience of description, and the scope of filtering in the present disclosure is not limited to deblurring, and filtering in the present disclosure may include a variety of filtering such as super resolution, deblurring, denoising, temporal resampling, spatial resampling upsampling, downsampling, etc. In addition, filtering in the present disclosure may include all of filtering performed within a process, preprocessing filtering performed before a process and post-processing filtering performed after a process.

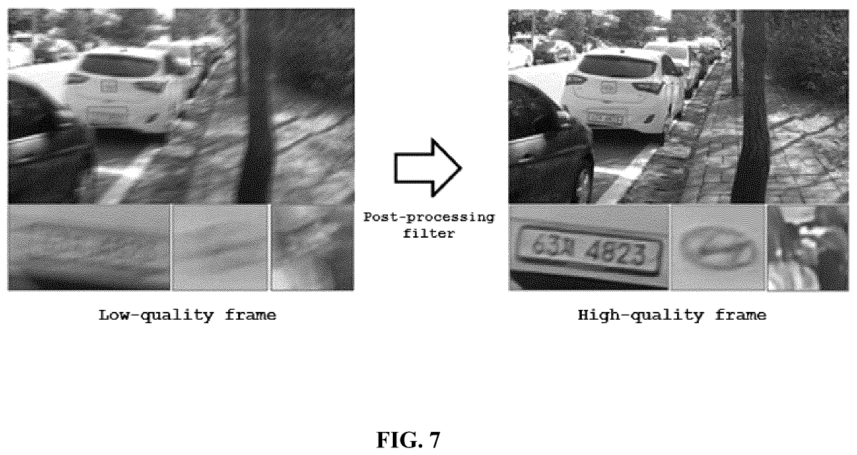

FIG. 7 is a diagram for describing an embodiment of a post-processing filter mentioned in the present disclosure.

An image quality difference between video frames that may degrade encoding performance for machines may be reduced through a post-processing process 480. As an example, a deblurring post-processing process, as shown in FIG. 7, may convert a blurry low-quality image into a clear high-quality image. In this case, a deblurring post-processing technology includes a technology for utilizing the full sharpness obtained through a clear learning image and a technology for utilizing the average sharpness between consecutive frames. However, each deblurring method may have the following restriction in its use.

A method for utilizing the full sharpness is a method for applying deblurring in the unit of a frame, which may convert a low-quality frame to be similar to the learned full sharpness. In this case, when a high-quality frame, not a low-quality frame, is input, a wave pattern error or an unnatural color error may occur in a part of an image.

On the other hand, a method for utilizing the average sharpness between the consecutive frames of a video may have a restriction that although deblurring is applied to a high-quality frame, an error is reduced, but deblurring is not effective when consecutive frames are a low-quality frame. Since this restriction is due to an inability to specify which frame is a low-quality frame within a video frame, the present disclosure proposes a VSEI message that may search for a low-quality frame within a video frame and provide information on the low-quality degree of a corresponding frame.

As another embodiment, a method for directly including the VSEI message in a bitstream and transmitting it instead of VSEI NAL is also possible.

A video coding technology for machine mentioned in the present disclosure is a type of image compression, which may require the process of a video encoder 430 and a video decoder 440. Accordingly, a corresponding process may cause image information loss due to compression, and the performance of utilizing a machine task for an image where information is lost may be degraded. Accordingly, a denoising post-processing process that reconstructs lost image information may be utilized, but the application of a post-processing process that does not consider the degree of image information loss may rather degrade the performance of a machine task. Accordingly, for a post-processing process that improves the performance of a machine task, it is necessary to transmit information on the loss degree of image information to a decoder side.

When a traditional video codec such as HEVC or VVC is utilized in a video coding technology for machine, the loss degree of image information may be transmitted as a quantization parameter (QP) value which is the degree of compression. However, due to a change in a QP value applied for each video frame according to the compression mode of a video codec or a procedure for considering temporal redundancy, a set QP value is just an overall figure for the entire image configuring a video, and may be insufficient in expressing the loss degree of individually configured image information.

Meanwhile, a video coding technology for machine includes not only traditional video codecs but also deep learning-based still image/video codecs, and in the algorithm of these codecs, there are various compression condition variables that are similar in the existing QP values and functions but are different in expressions and figures. As an example, in a corresponding technology, compression degree may be adjusted through a quality variable, but since the effect of a corresponding variable is different for each individual algorithm, there is a difficulty in that data information for all video compression codecs must be included in order for compression condition information to be utilized as the loss degree of image information at a decoder side. Accordingly, a method for consistently transmitting information on the loss degree of image information required for a post-processing process may be required to improve the performance of a machine task.

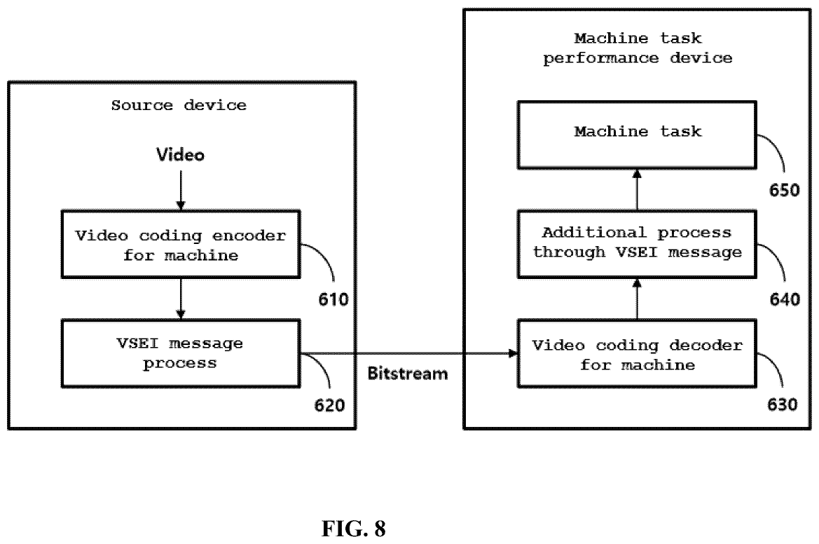

FIG. 8 is a diagram for describing a step for generating, transmitting and utilizing an image quality assessment message for video coding for machine (VCM) in the present disclosure.

As shown in FIG. 8, an image quality assessment message to which video coding for machine in the present disclosure is applied may perform at least one of a video preprocess for generating a VSEI message 610, an encoding encoder for a machine 620, a video coding decoder for a machine 630, an additional process through a VSEI message 640 or a machine task 650 process. As an example, an image quality assessment message to which video coding for machine in the present disclosure is applied may perform all of the processes 610 to 650 or may omit some processes.

The main proposal of the present disclosure may correspond to a video preprocess for generating a VSEI message 610 and an additional process through a VSEI message 640. However, the proposal of the present disclosure may include a category in which an image quality assessment message to which video coding for machine in the present disclosure is applied is utilized as single information in i) sequence level temporal resampling 400 which is an internal process of a video coding encoder for machine 620; and ii) sequence level temporal resampling reconstruction 470 which is an internal process of a video coding decoder for machine 630.

As another embodiment, a method for directly including the VSEI message in a bitstream and transmitting it instead of VSEI NAL is also possible.

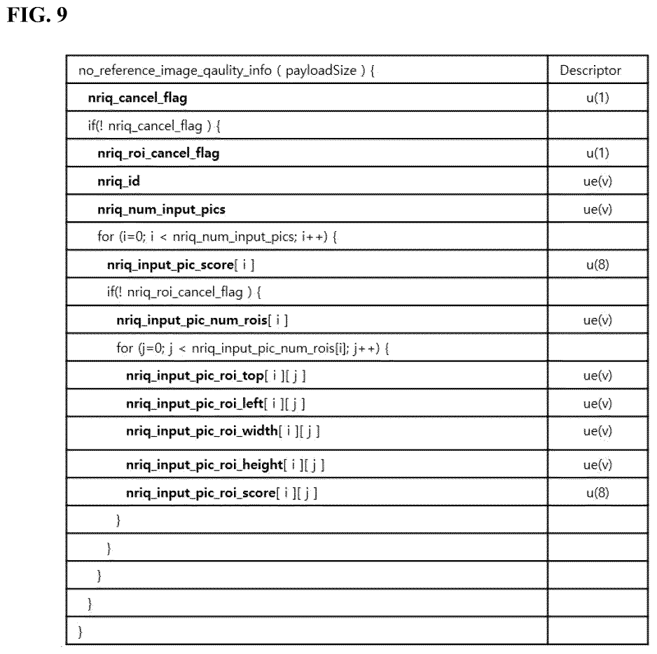

FIG. 9 shows an embodiment of an image quality assessment message for video coding for machine (VCM) in the present disclosure.

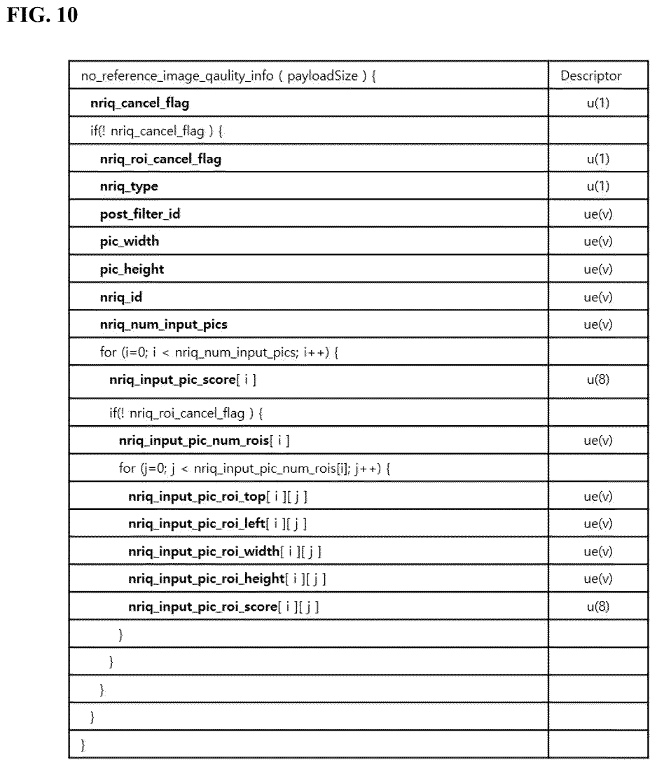

FIG. 10 shows an embodiment of an image quality assessment message for video coding for machine (VCM) in the present disclosure.

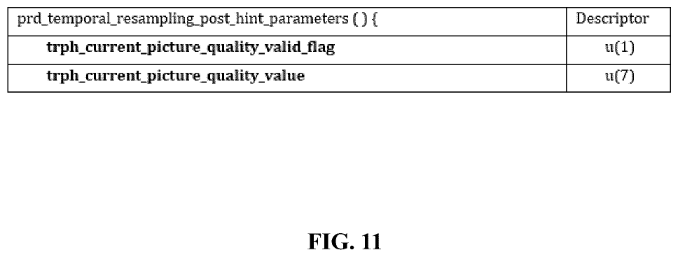

FIG. 11 shows an embodiment of an image quality assessment message for video coding for machine (VCM) in the present disclosure.

The image quality assessment information of the present disclosure is information representing a non-reference image quality assessment score obtained by a non-reference image quality assessment (NRIQA) method, and may be included in the non-reference image assessment information of the present disclosure.

In an embodiment of the present disclosure, an image quality assessment message for video coding for machine (VCM) has the same structure as shown in FIG. 9, FIG. 10 or FIG. 11, wherein the meaning of a syntax element may be given as follows.

nriq_cancel_flag may represent whether to generate non-reference image assessment information for a current input video sequence or whether non-reference image assessment information is valid. As an example, when nriq_cancel_flag has a value of 0, nriq_cancel_flag may represent that non-reference image assessment information is generated for a current input video sequence or that the information is valid. In contrast, when nriq_cancel_flag has a value of 1, nriq_cancel_flag may represent that this flag should be ignored.

nriq_roi_cancel_flag may represent whether to generate non-reference image assessment information per region of interest for a current input video sequence or whether non-reference image assessment information is valid. As an example, when nriq_roi_cancel_flag has a value of 0, nriq_roi_cancel_flag may represent that non-reference image assessment information per region of interest is generated for a current input video sequence or that the information is valid. In contrast, when nriq_roi_cancel_flag has a value of 1, nriq_roi_cancel_flag may represent that this flag should be ignored.

nriq_type may represent defining in ascending order that non-reference image assessment determines that an image has high quality. As an example, when nriq_type has a value of 0, nriq_type may represent defining in descending order that non-reference image assessment determines that an image has high quality. As an example, when nriq_type has a value of 1, nriq_type may represent defining in ascending order that non-reference image assessment determines that an image has high quality.

post_filter_id may include the identification number of a post-processing process and the function of a post-processing process. A post_filter_id value may be used as determined by application and may be reserved for future use by ITU-Tj ISO/IEC.

pic_width and pic_height may represent the number of horizontal image pixels and the number of vertical image pixels of an image.

nriq_id may represent the identification number of a non-reference image assessment method which will assess a video frame. A nriq_id value may be used as determined by application and may be reserved for future use by ITU-Tj ISO/IEC.

nriq_input_pic_score[i] may represent a non-reference image assessment score in the i-th frame.

As an example, the i-th frame may represent a current frame (picture), and accordingly, nriq_input_pic_score may represent the non-reference image assessment score of a current picture.

Specifically, nriq_input_pic_score[i] may utilize the minimum value minScore and the maximum value maxScore of a score that may be assessed by a non-reference image assessment method itself to express the score curScore of the i-th frame as a value from 0 to 255, which may be represented as in Equation (1).

$$nriq\_input \_pic \_score = \frac{curScore - minScore}{maxScore - minScore} \times 255 \qquad Equation ( 1 )$$

nriq_input_pic_num_rois[i] may represent the number of regions of interest in the i-th frame. As an example, the i-th frame may represent a current frame (picture), and accordingly, nriq_input_pic_num_rois may represent the number of regions of interest of a current picture.

nriq_input_pic_roi_top[i][j], nriq_input_pic_roi_left[i][j], nriq_input_pic_roi_width[i][j] and nriq_input_pic_roi_height[i][j] represent position information for the j-th region of interest of the i-th frame from the perspective of a rectangular region designated with an image coordinate, which may represent the width and height of a rectangle based on the coordinate of a top-left vertex from the perspective of a rectangular region, respectively.

nriq_input_pic_roi_score[i][j] may represent the non-reference image assessment score of the j-th region of interest image in the i-th frame.

As an example, the i-th frame may represent a current frame (picture), and accordingly, nriq_input_pic_roi_score may represent the non-reference image assessment score of a specific region of interest image of a current picture.

Specifically, nriq_input_pic_roi_score[i][j] may utilize the minimum value minScore and the maximum value maxScore of a score that may be assessed by a non-reference image assessment method itself to express the score curScore of the i-th frame as a value from 0 to 255, which may be represented as in Equation (2).

$$nriq\_input \_pic \_roi \_score = \frac{curScore - minScore}{maxScore - minScore} \times 255 \qquad Equation ( 2 )$$

As an example, since nriq_input_pic_score is transmitted for all frames of a video, the maximum value (max_nriq_pics_score) and the minimum value (min_nriq_pics_score) of an assessment value may be obtained from a plurality of nriq_input_pic_score values. Based on the corresponding maximum value and minimum value, an assessment value for the i-th frame (cur_nriq_pic_score(i)) is expressed as a nriq_input_pic_score_percent value between 0 and 100 as shown in Equation (3), so the image quality of a current frame (picture) may be classified.

As an example, for values A, B and C between 0 and 100 defined in ascending order, a frame less than or equal to A may be classified as a distorted image for the entire image, a frame greater than A and less than or equal to B may be classified as an image which is mostly distorted for an image, but is partially clear, a frame greater than B and less than or equal to C may be classified as an image which is partially distorted for an image and an image greater than C may be classified as a clear image.

When nriq_type has a value of 0 and is defined in descending order, its utilization may be performed in the opposite way from the above.

$$nriq\_input \_pic \_score \_percent ( \% ) = \frac{cur\_nriq \_pic \_score ( i ) - min\_nriq \_pics \_score}{max\_nriq \_pics \_score - min\_nriq \_pics \_score} \times 100 \qquad Equation ( 3 )$$

The image quality assessment information validity information may be expressed in the form of a flag such as trph_current_frame_quality_valid_flag. Specifically, as in Equation (5), when the ratio of a region of interest is less than a threshold value, the image quality assessment information validity information may have a value of 0, and when the ratio of a region of interest is equal to or greater than a threshold value, the image quality assessment information validity information may have a value of 1.

As an example, when trph_current_frame_quality_valid_flag has a value of 1, the flag may represent that the filtering of the present disclosure (e.g., temporal post-processing filtering, spatial post-processing filtering, etc.) is performed. In this case, the filtering of the present disclosure may be performed based on image quality assessment information (e.g., trph_current_frame_quality_value).

In contrast, when trph_current_frame_quality_valid flag has a value of 0, it may represent that image quality assessment information for a current frame or a current image is invalid. In this case, the filtering of the present disclosure may be performed without considering image quality assessment information (e.g., trph_current_frame_quality_value) or may not be performed.

A threshold value compared to the ratio of a region of interest may be determined as the representative value of the ratio of a region of interest of frames of a current image. Here, a representative value may be an average value, a weighted average value, a maximum value, a minimum value, a mode value, etc. Alternatively, a threshold value compared to the ratio of a region of interest may be a value signaled from a bitstream or predefined in an encoder/a decoder.

The image quality assessment information of the present disclosure may represent a non-reference image quality assessment score (e.g., a NRIQA value).

Based on the image quality classification, in a post-processing process 480 utilizing full sharpness, selective deblurring may be applied to a low-quality frame, not a high-quality frame.

In addition, a deblurring post-processing process 480 for configuring a low-quality frame between adjacent high-quality frames and utilizing average sharpness between consecutive frames may be performed by distinguishing between a high-quality frame and a low-quality frame based on the image quality classification.

As an example, in a post-processing process for utilizing full sharpness and a post-processing process for utilizing average sharpness between consecutive frames, deblurring may be selectively applied only to a frame less than or equal to A according to image quality classification. Alternatively, in a post-processing process for utilizing full sharpness and a post-processing process for utilizing average sharpness between consecutive frames, deblurring may be selectively applied only to a frame less than or equal to B according to image quality classification. Alternatively, in a post-processing process for utilizing full sharpness and a post-processing process for utilizing average sharpness between consecutive frames, deblurring may be selectively applied only to a frame less than or equal to C according to image quality classification.

According to an embodiment of the present disclosure, when an image quality score obtained from a decoded video is utilized without utilizing the present disclosure, the sharpness classification of an image texture may be limited because an image quality score varies significantly due to a quantization parameter value that is set differently for each frame according to an encoding method, so the image quality assessment message of the present disclosure may be necessary.

According to another embodiment of the present disclosure, nriq_input_pic_score[i] for the i-th frame transmitted through a VSEI message and a score nriq_dec_pic_score[i] obtained by performing a non-reference image assessment on the i-th frame of a decoded video may be utilized to calculate dec_pic_deg_percent, the loss degree of image information of the i-th frame, as shown in Equation (4). In this case, applying a post-processing process 480 to the i-th frame of a decoded video may be selectively performed through the critical range of dec_pic_deg_percent.

$$dec\_pic \_deg \_percent ( \% ) = \frac{nriq\_input \_pic \_score [ i ] - nriq\_dec \_pics \_score [ i ]}{nriq\_input \_pic \_score [ i ]} \times 100 \qquad Equation ( 4 )$$

The implementation does not limit utilization only in the unit of a frame, and its utilization may be replaced with nriq_input_pic_roi_score[i][j] and nriq_dec_pic_roi_score[i][j] for the j-th roi region within the i-th frame.

According to an embodiment of the present disclosure, the image quality of a current frame may be further materialized through difference information between an image quality assessment message generated through the present disclosure and image quality assessment information (or an image quality assessment score) obtained from a decoded video, and a post-processing module that selects or combines an image quality improvement technology such as super resolution, deblurring, denoising, etc. may be utilized based on the corresponding difference information.

According to an embodiment of the present disclosure, filtering such as super resolution, deblurring, denoising, temporal resampling, etc. may be selectively performed based on an image quality assessment message. An image quality assessment message may be signaled by a bitstream, and may include the image quality assessment information validity information and image quality assessment information of the present disclosure.

According to a specific embodiment of the present disclosure, the image quality of a current frame may be further materialized through difference information between an image quality assessment message generated through the present disclosure and image quality assessment information obtained from a decoded video (or difference information of an image quality assessment score), and a post-processing module that selects or combines an image quality improvement technology such as super resolution, deblurring, denoising, spatial resampling, temporal resampling, upsampling, downsampling, etc. may be utilized based on image quality assessment difference information.

As an example, as in an example where deblurring is selectively applied in a post-processing process according to the image quality classification (whether it is less than or equal to A, B or C), super resolution, denoising, etc. may also be selectively applied according to the image quality classification (whether it is less than or equal to A, B or C).

The image quality assessment message of the present disclosure may include image quality assessment information validity information representing whether image quality assessment information is valid by considering a region of interest.

Image quality assessment information validity information may be determined based on the ratio of a region of interest of a frame to the entire region of a frame.

Image quality assessment information validity information may be expressed in the form of a flag.

As an example, when image quality assessment information validity information has a value of 0, the image quality assessment information validity information may represent that image quality assessment information for a current frame or a current image is not valid. In this case, the filtering of the present disclosure may be performed regardless of image quality assessment information for a current frame or a current image. Alternatively, the filtering of the present disclosure may not be performed for a current frame or a current image.

As an example, when image quality assessment information validity information has a value of 1, the image quality assessment information validity information may represent that image quality assessment information for a current frame or a current image is valid. In this case, the filtering of the present disclosure may be performed by considering image quality assessment information for a current frame or a current image.

As an embodiment, when the ratio of a region of interest of a frame to the entire region on a frame is greater than a threshold value, the image quality assessment information validity information may represent that the image quality assessment information is valid information.

Here, a threshold value may be signaled from a bitstream or may be a pre-defined value. For example, a threshold value may be 75%, 50%, 45%, 30%, 25%, 15%, 10%, etc.

The image quality assessment information of the present disclosure is transmitted in the unit of a frame, and may be transmitted for all frames or only some frames of an image.

As an embodiment, the image quality assessment information of the present disclosure may be transmitted for all frames.

As an embodiment, the image quality assessment information of the present disclosure may be transmitted only for some frames. For example, when a first frame, a second frame and a third frame are assumed in order of frame, the image quality assessment information of a second frame may be implicitly determined based on at least one of the image quality assessment information of a first frame or the image quality assessment information of a third frame. In other words, the image quality assessment information of a first frame and a third frame may be signaled through a bitstream.

A standard for image quality classification to which super resolution, deblurring, denoising, etc. are selectively applied may be different from each other. As an example, a standard for selectively applying deblurring is a case where image quality classification is less than or equal to B, but a standard for selectively applying denoising is a case where image quality classification is less than or equal to C, so a standard for image quality classification that is applied selectively each other may be different.

FIG. 11 is a diagram for describing a case where a coding technology for machines in the present disclosure is utilized as an element technology in a temporal resampling reconstruction process.

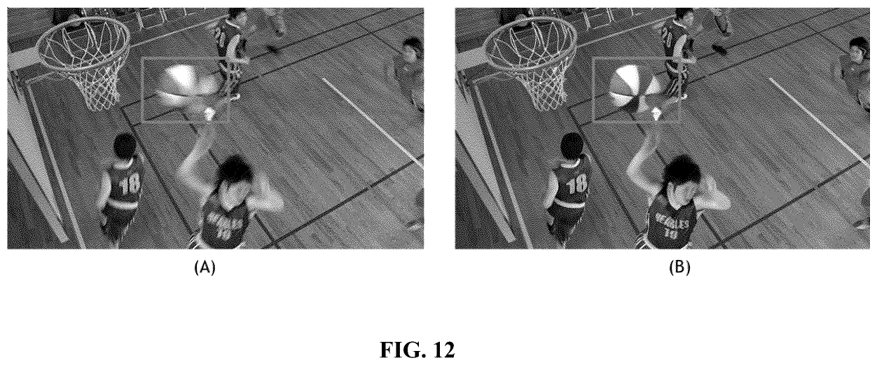

According to an embodiment of the present disclosure, the image quality assessment message of the present disclosure may be utilized to generate a higher quality image in the temporal resampling reconstruction 470 of a video coding process for machine (VCM). As an example, an intermediate frame generated through the temporal resampling reconstruction process of the existing video coding for machine is shown as in FIG. 12(A), and performing a temporal resampling reconstruction process after searching for a low-quality frame and applying deblurring to a corresponding frame through the present disclosure may be shown as in FIG. 12(B). As shown in the rectangular region with bold lines of FIGS. 12(A) and (B), it may be confirmed that a more improved intermediate image is generated in a temporal resampling reconstruction process applied in the present disclosure.

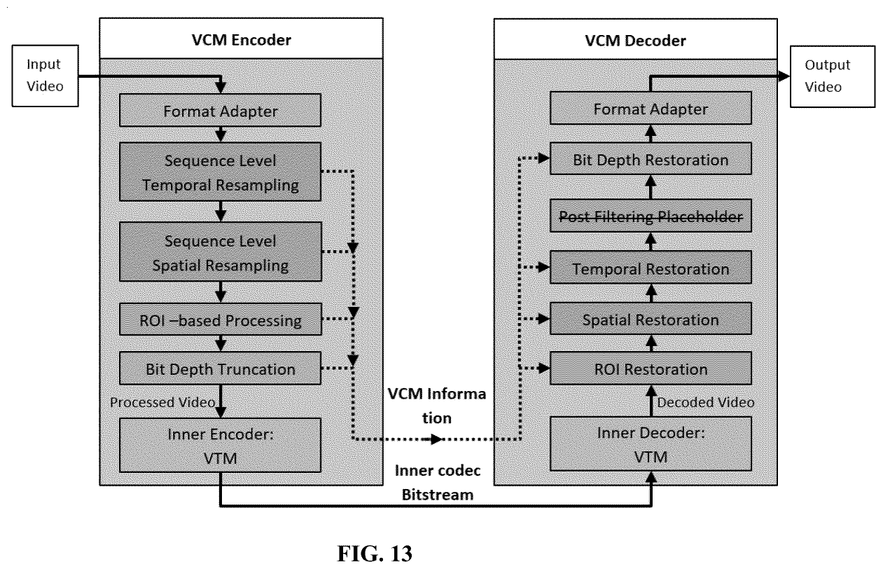

FIG. 13 shows a MPEG VCM encoder/decoder structure diagram.

Since ROI Tool provides the most performance in VCM, when ROI Tool is used, the proposal of the present disclosure may also extract an image quality message by considering it.

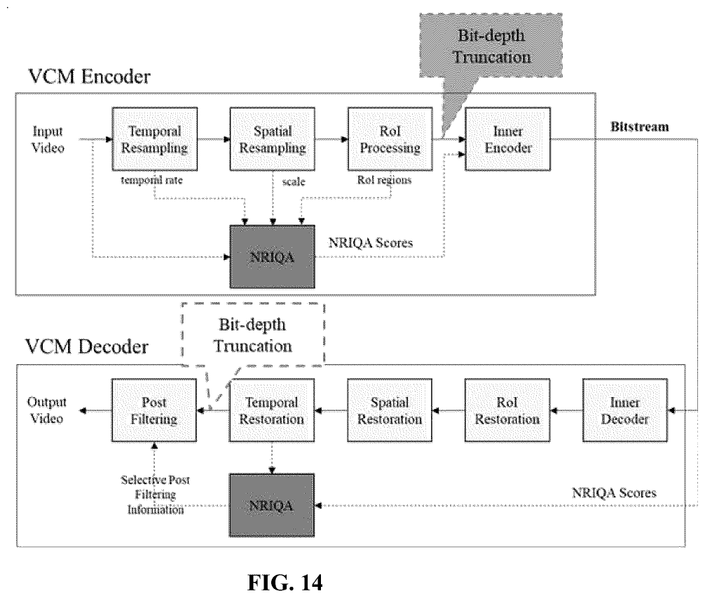

FIG. 14 shows an embodiment in which an image quality assessment message is extracted.

Referring to FIG. 14, the measurement of an image quality assessment score may be performed in a non-reference image quality assessment (NRIQA) block. In this case, a NRIQA input may use an input image.

In order to measure NRIQA by considering the application information of each Tool, the information of each Tool or a processed image may be transmitted to a NRIQA block.

A decoder may use a reconstructed image before applying post-filtering as an NRIQA input and control the application of post-filtering through a comparison with a NRIQA score transmitted from an encoder.

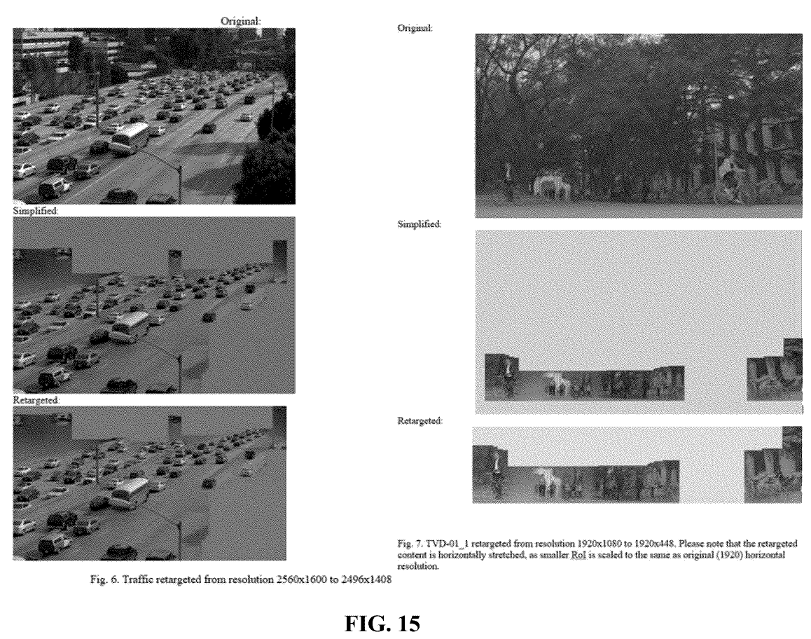

FIG. 15 shows an embodiment of a ROI processing process of VCM.

The ROI processing process of VCM may include graying out a region other than a ROI and applying spatial downsampling for each ROI region and for each region other than a ROI by considering ROI importance.

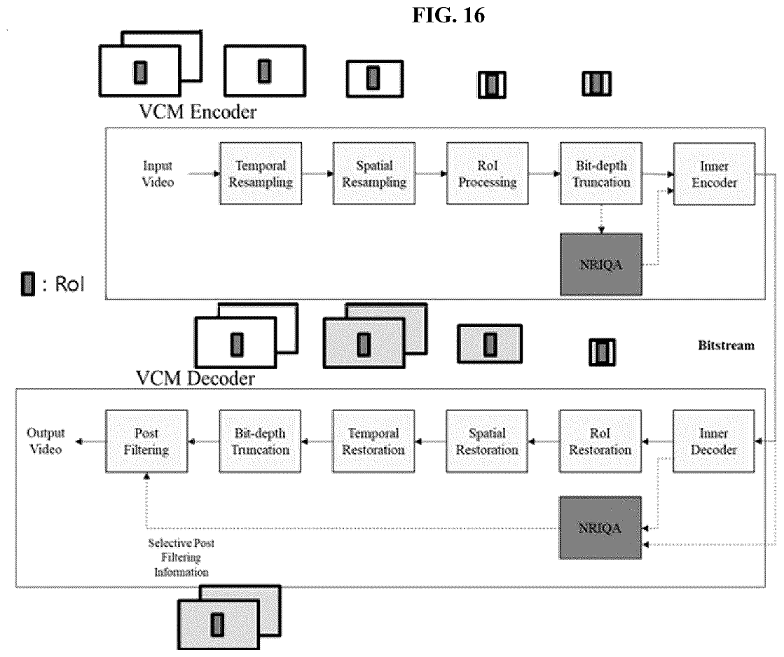

FIG. 16 shows another embodiment in which an image quality assessment message is extracted.

A NRIQA input in an encoder may use an image that all processings are performed, such as a ROI, etc. In other words, an Inner Encoder input may be used. A NRIQA input in a decoder may use an Inner Decoder output in response thereto.

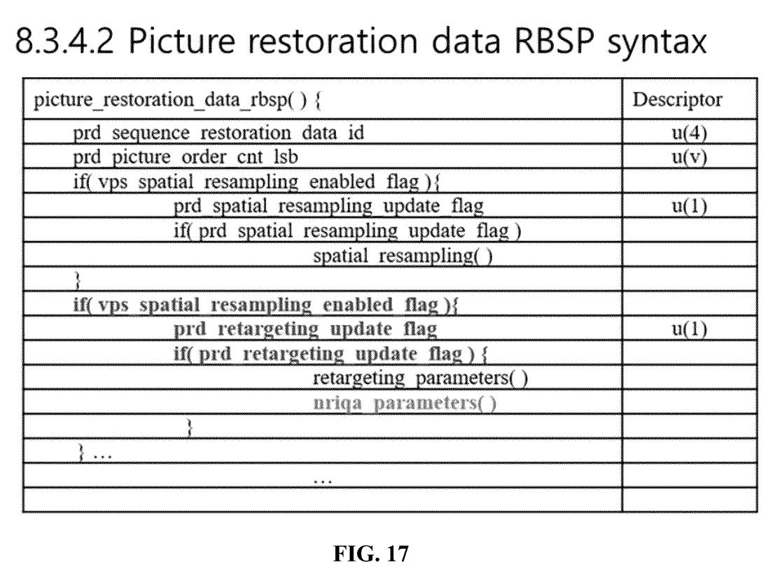

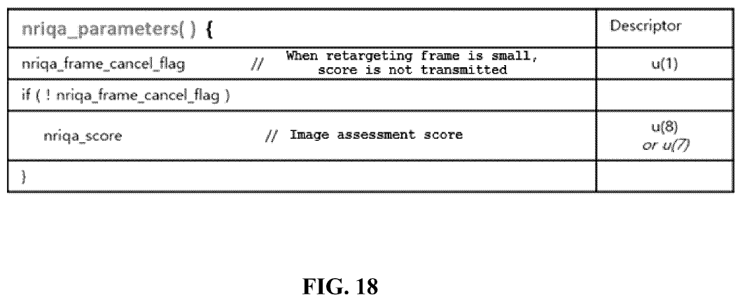

FIGS. 17 and 18 show another embodiment of a syntax element for conveying image quality assessment information for video coding for machine (VCM) in the present disclosure.

nriqa_score is a value obtained from a NRIQA block in an encoder, and may be information included in a bitstream and transmitted to a decoder. Corresponding information may be obtained and transmitted for each frame. In other words, it may be transmitted in the unit of a frame.

As another embodiment, corresponding information may be transmitted for the first frame of GoP, i.e., for each Intra period. In this case, other frames within GoP may use the score of Intra as it is. In other words, corresponding information may be transmitted only for the first frame of each Intra period.

As another embodiment, in VCM, corresponding information may be transmitted differently from the GoP of an Inner codec. For example, ROI information may define a ROI accumulation period and may be transmitted for each period. Similarly, nriqa_score may also determine a period for transmitting information and may be transmitted for each determined period.

As another embodiment, when applying a ROI, the ratio of a ROI region in the entire image may be measured. When the ratio is less than or equal to a specific threshold, nriqa_score may not be transmitted. It may be because when the ROI tool of VCM is used, the outside of a ROI region is grayed out, and when a ROI region is small, a grayed-out region affects nriqa_score measurement, resulting in measuring a meaningless value.

When nriqa_score transmitted to an encoder and nriqa_score measured by a decoder are greater than or equal to a specific threshold, post-processing (post filtering) may be selectively applied. Alternatively, post-processing may be applied only when it is less than or equal to a threshold. A decision to selectively apply post-processing may be maintained within one score period.

As another example, for a case in which it is applied when a difference between the score of an encoder and the score of a decoder is greater than or equal to a threshold, when the temporal resampling tool of VCM is applied, i.e., when temporal downsampling is applied in an encoder and temporal upsampling is applied in a decoder, a target to which filtering is selectively applied may also be applied only to a frame that is generated through temporal upsampling in a decoder. As another embodiment, regardless of this, when it is a section where filtering is applied selectively, it may also be applied to all frames.

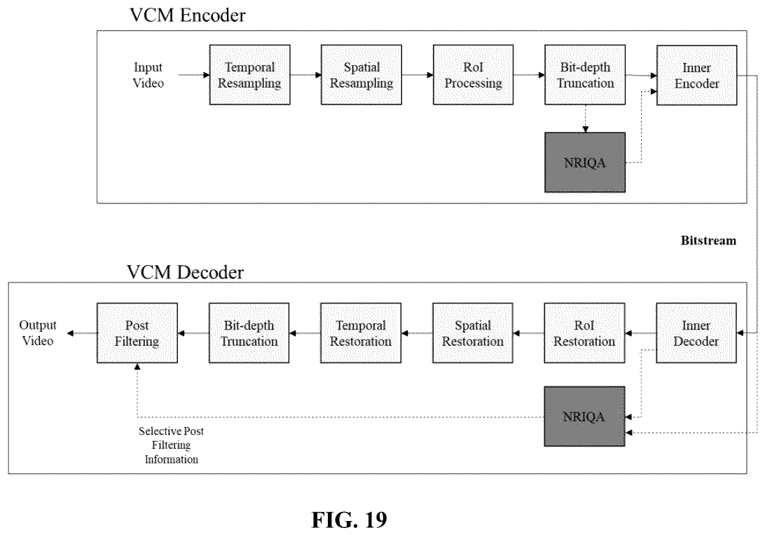

FIG. 19 shows a flowchart for a VCM encoder and a VCM decoder according to an embodiment of the present disclosure.

The NRIQA process of the present disclosure is information for determining whether filtering (e.g., temporal post-filter or spatial post-filter) will be applied to which frame among the frames interpolated in a temporal resampling process, and may perform Non-Reference Image Quality Assessment (NRIQA). As an embodiment, the non-reference image assessment may be performed by a non-reference image assessment method described above, and a non-reference image assessment score may be obtained and updated to non-reference image assessment information (=image quality assessment information).

A NRIQA process may be performed in the following steps on an encoder side.

### 1. a Step for Initializing Information

Based on all or a part of the sampled frames of an image, image quality assessment information validity information (e.g., trph_current_frame_quality_valid_flag) and image quality assessment information (e.g., trph_current_frame_quality_value) may be initialized.

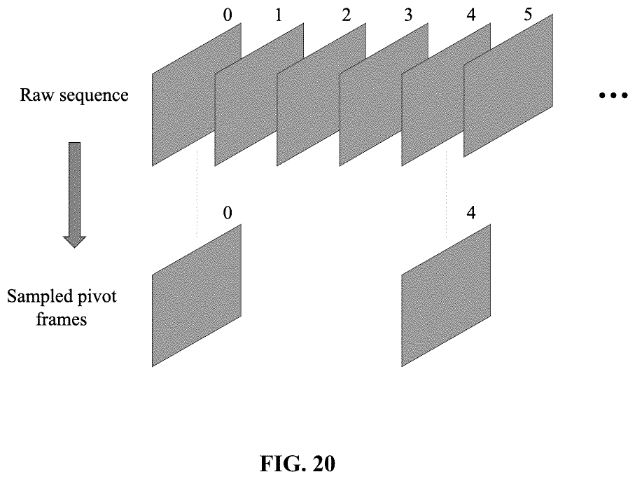

FIG. 20 shows an example of each sampled pivot frame in temporal resampling.

As an embodiment, as in FIG. 20, trph_current_frame_quality_valid_flag and trph_current_frame_quality_value of each sampled pivot frame may be initialized in temporal resampling.

### 2. a Step for Updating Image Quality Assessment Information Validity Information

In this step, image quality assessment information validity information may be updated in the unit of a frame for the entire frame or a partially sampled frame of an image based on the ratio of a region of interest (roi_ratio) obtained from RoI processing.

Here, the ratio of a region of interest may represent the ratio of a corresponding region of interest to the entire region of a current frame.

Here, a current frame may be a partially sampled frame among all frames of an image.

As an example, image quality assessment information validity information may be expressed in the form of a flag such as trph_current_frame_quality_valid_flag. Specifically, as in Equation (5), when the ratio of a region of interest is less than a threshold value, the image quality assessment information validity information may have a value of 0, and when the ratio of a region of interest is equal to or greater than a threshold value, the image quality assessment information validity information may have a value of 1.

As an example, when trph_current_frame_quality_valid_flag has a value of 1, the flag may represent that the filtering of the present disclosure (e.g., temporal post-processing filtering, spatial post-processing filtering, etc.) is performed. In this case, the filtering of the present disclosure may be performed based on image quality assessment information (e.g., trph_current_frame_quality_value).

In contrast, when trph_current_frame_quality_valid_flag has a value of 0, it may represent that image quality assessment information for a current frame or a current image is invalid. In this case, the filtering of the present disclosure may be performed without considering image quality assessment information (e.g., trph_current_frame_quality_value) or may not be performed.

A threshold value compared to the ratio of a region of interest may be determined as the representative value of the ratio of a region of interest of all or a part of frames of a current image. Here, a representative value may be an average value, a weighted average value, a maximum value, a minimum value, a mode value, etc. Alternatively, a threshold value compared to the ratio of a region of interest may be a value signaled from a bitstream or predefined in an encoder/a decoder.

$$trph\_current \_frame \_quality \_valid \_flag = \{ \begin{matrix}0 , if roi\_ratio < {Threshold}_{roi , ratio} \\ 1 , otherwise\end{matrix} \qquad Equation ( 5 )$$

### 3. A Step for Updating Image Quality Assessment Information

A non-reference image quality assessment score (e.g., a NRIQA value) may be obtained in the unit of a frame for the entire frame or a partially sampled frame of an image according to an image quality assessment method and may be updated to image quality assessment information (e.g., trph_current_frame_quality_value).

As an example, a NRIQA value may be obtained in the unit of a frame for a bit-depth truncated frame that a bit depth is reduced or truncated or a downsampled frame and a corresponding value may be updated to trph_current_frame_quality_value.

In this case, an image quality assessment score (a NRIQA value) is expressed as a decimal value between 0 and 1, so it may be multiplied by (2\hat{ }7−1) and converted into a value from 0 to 127 and then, may be updated to image quality assessment information.

### 4. a Step for Transmitting an Image Quality Assessment Message

The image quality assessment information validity information and image quality assessment information of an image quality assessment message may be transmitted to a decoder side in the unit of a frame for the entire frame or a partially sampled frame of an image.

As an example, trph_current_frame_quality_valid_flag and trph_current_frame_quality_value may be transmitted to a decoder side in the unit of each frame.

A NRIQA process may be performed in the following steps on a decoder side.

### 1. a Step for Measuring an Image Quality Assessment Score

The image quality assessment score (e.g., NRIQA value) of a decoded frame obtained from an inner decoder may be estimated in the unit of the entire frame or some frames of an image. Here, some frames may represent the same frame as a sampled frame on an encoder side.

The period of sampling may be determined by a temporal resampling period (or rate). Here, the period of temporal resampling may be explicitly signaled from a bitstream or may be implicitly determined by signaled information.

### 2. A Step for Obtaining an Image Quality Assessment Score

When an image quality assessment score is measured in the unit of some frames in a step for measuring an image quality assessment score, the image quality assessment score of intermediate frames interpolated through temporal resampling (between some frames) may be obtained based on the image quality assessment score of the some frames.

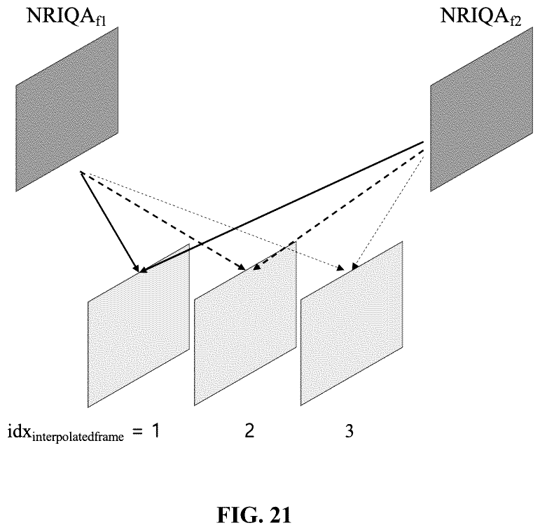

FIG. 21 shows an embodiment in which an image quality assessment score of intermediate frames interpolated through temporal resampling is obtained.

As an embodiment, referring to FIG. 21, the image quality assessment score of intermediate frames may be obtained by using Equation (6) below.

$$interva1 = {2}^{( srd\_temporal \_resampling \_ratio \_idx \div 1 )} \qquad Equation ( 6 )$$

$${NRIQA}_{interpolated\_frame} [ {idx}_{interpolatedframe} ] = ( N R I Q {A}_{f 2} - {NRIQA}_{f 1} ) / interval * ( {idx}_{interpolatedframe} ) + {NRIQA}_{f 1}$$

Here, interval may represent an interval between some sampled frames related to an intermediate frame. It may be obtained based on a temporal resampling period.

As an example, the NRIQA value of idx_{interpoiated_frame}=1 may be obtained as the NRIQA value of a f1 frame*the NRIQA value of a ¾+f2 frame*a ¼ value in FIG. 21.

As an example, the NRIQA value of idx_{interpoiated_frame}=2 may be obtained as the NRIQA value of a f1 frame*the NRIQA value of a ½+f2 frame*a ½ value in FIG. 21.

As an example, the NRIQA value of idx_{interpoiated_frame}=3 may be obtained as the NRIQA value of a f1 frame*the NRIQA value of a ¼+f2 frame*a ¾ value in FIG. 21.

### 3. a Step for Performing Filtering

When the image quality assessment score of an obtained frame satisfies a specific condition, the filtering of the present disclosure may be performed for a corresponding frame. In other words, only when a specific condition is satisfied, filtering may be selectively performed.

As an example, as described above, filtering may be performed only when an image quality assessment score is greater than a threshold value.

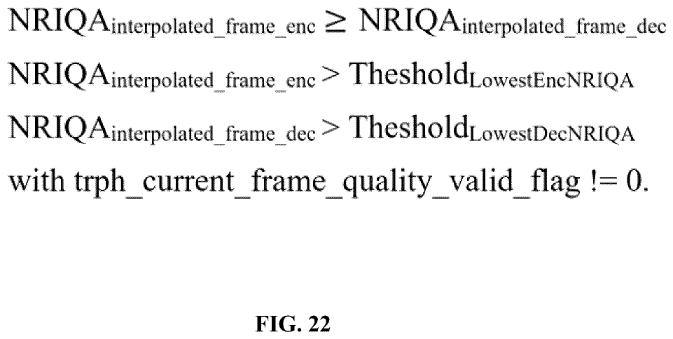

FIG. 22 shows an embodiment of a condition in which filtering for intermediate frames interpolated through temporal resampling is selectively performed.

Referring to FIG. 22, as an embodiment, when i) the image quality assessment information validity information of a partially sampled frame related to interpolated intermediate frames represents that image quality assessment information is valid (trph_current_frame_quality_valid_flag l=0); ii) a NRIQA value obtained from an encoder is greater than a NRIQA value obtained from a decoder; iii) a NRIQA value obtained from an encoder is greater than a threshold value; and iv) a NRIQA value obtained from a decoder is greater than a threshold value, the filtering of the present disclosure may be performed for interpolated intermediate frames.

As a condition in i) above has a value of 1 and is transmitted from an encoder side when a RoI ratio is greater than a threshold value, it may represent that a RoI ratio is a meaningful ratio within a corresponding frame.

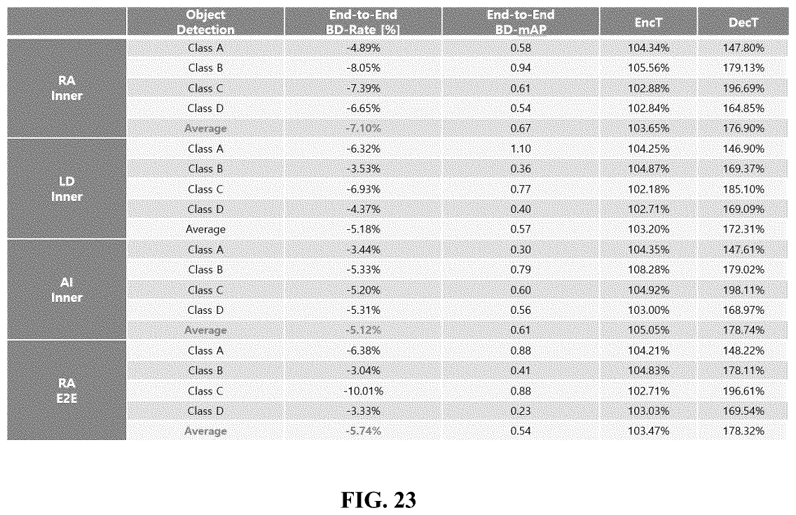

FIG. 23 shows a VCM CTC experiment result according to the present disclosure.

The name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as FPGA, a GPU, other electronic device or a combination thereof. At least some of functions or processes described in illustrative embodiments of the present disclosure may be implemented by software, and software may be recorded in a recording medium. A component, a function and a process described in illustrative embodiments may be implemented by a combination of hardware and software.

A method according to an embodiment of the present disclosure may be implemented by a program which may be performed by a computer, and the computer program may be recorded in a variety of recording media such as a magnetic storage medium, an optical readout medium, a digital storage medium, etc.

A variety of technologies described in the present disclosure may be implemented by a digital electronic circuit, computer hardware, firmware, software or a combination thereof. The technologies may be implemented by a computer program product, i.e., a computer program tangibly implemented on an information medium or a computer program processed by a computer program (e.g., a machine readable storage device (e.g., a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language, and may be distributed in any form including a stand-alone program or module, a component, a sub-routine or other units suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and at least one processor of a digital computer. Generally, a processor receives an instruction and data in a read-only memory or a random access memory or both of them. The component of a computer may include at least one processor for executing an instruction and at least one memory device for storing an instruction and data. In addition, a computer may include at least one mass storage device for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, a ROM (Read Only Memory), a RAM (Random Access Memory), a flash memory, an EPROM (Erasable Programmable ROM), an EEPROM (Electrically Erasable Programmable ROM) and other known computer readable media. A processor and a memory may be complemented or integrated by a special-purpose logic circuit.

A processor may execute an operating system (OS) and at least one software application executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer, and may include both a computer storage medium and a transmission medium.

The present disclosure includes a detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination or the combination may be described as being initially claimed, but in some cases, at least one feature may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments, and the above-described program component and device may be packaged into a single software product or multiple software products.

Illustrative embodiments disclosed herein are just illustrative and do not limit the scope of the present disclosure. Those skilled in the art may recognize that illustrative embodiments may be variously modified without departing from a claim and the spirit and scope of its equivalent.

Accordingly, it may be said that the present disclosure includes all other replacements, modifications and changes belonging to the following claims.

1. An image decoding method, the method comprising:
receiving an image quality assessment message from a bitstream;
determining whether to perform a filtering based on image quality assessment information of the image quality assessment message; and
selectively performing a filtering of a current frame based on whether to perform the filtering.

2. The method of claim 1, wherein:
the current frame is a frame interpolated through a temporal resampling.

3. The method of claim 2, wherein determining whether to perform the filtering includes:
determining whether the image quality assessment information is valid; and
in response to the image quality assessment information being valid, determining whether to perform the filtering based on the image quality assessment information.

4. The method of claim 3, wherein:
whether the image quality assessment information is valid is determined by a flag value included in the image quality assessment message.

5. The method of claim 4, wherein:
whether to perform the filtering is determined based on whether an image quality assessment score of the current frame is greater than a threshold value.

6. The method of claim 5, wherein:
the image quality assessment score of the current frame is obtained based on an image quality assessment score of frames obtained at a temporal resampling period interval.

7. The method of claim 1, wherein:
whether to perform the filtering is determined based on whether the image quality assessment information is valid.

8. The method of claim 1, wherein:
whether to perform the filtering is determined by comparing an image quality assessment score obtained on an encoding side with an image quality assessment score obtained on a decoding side.

9. An image encoding method, the method comprising:
determining whether to perform a filtering of a current frame based on image quality assessment information;
selectively performing the filtering of the current frame based on whether to perform the filtering; and
transmitting an image quality assessment message that the image quality assessment information is encoded to a bitstream.

10. The method of claim 9, wherein:
the current frame is a frame interpolated through a temporal resampling.

11. The method of claim 10, wherein determining whether to perform the filtering includes:
determining whether the image quality assessment information is valid; and
in response to the image quality assessment information being valid, determining whether to perform the filtering based on the image quality assessment information.

12. The method of claim 11, wherein:
whether the image quality assessment information is valid is encoded in the image quality assessment message in a form of a flag.

13. The method of claim 12, wherein:
whether the image quality assessment information is valid is determined based on a ratio of a region of interest of the current frame.

14. The method of claim 13, wherein:
the ratio of the region of interest of the current frame represents a ratio of a region of interest of a current frame for an entire region of the current frame.

15. The method of claim 14, wherein:
whether to perform the filtering is determined based on whether an image quality assessment score of the current frame is greater than a threshold value.

16. The method of claim 15, wherein:
the image quality assessment score of the current frame is obtained based on an image quality assessment score of frames obtained at a temporal resampling period interval.

17. A method for transmitting a bitstream, the method comprising:
determining whether to perform a filtering of a current frame based on image quality assessment information;
selectively performing the filtering of the current frame based on whether to perform the filtering; and
transmitting an image quality assessment message in which the image quality assessment information is included to a bitstream.
